(19) United States
(12) Patent Application Publication
(10) Pub. No.: US 2005/0139464 A1
(43) Pub. Date: Jun. 30, 2005

(54) Gaseous fuel production reactors and methods

(76) Inventor: Charles A. McClure, Lexington, VA (US)

Correspondence Address: Charles A. McClure, P. O. Box 1369, Lexington, VA, 24450, US

(21) Appl. No.: 10/867,915

(22) Filed: Jun. 15, 2004

Related U.S. Application Data
(63) Continuation-in-part of application No. 10/750,393, filed on Dec. 31, 2003.

(51) Int. Cl. B01J 19/08; B01J 19/12

(52) U.S. Cl. 204/164; 422/186.04

(57) ABSTRACT

Production of non-self-combustible gaseous product, combustible with added air or other oxygen source, by electric-arc processing of water-slurried fragmented carbonaceous feedstock (e.g., anthracite ore, or graphite ore, or carbon-rich residue) within an appropriate high-temperature reactor defining a reaction zone, as by and between intermittently adjustably spaced-apart high-temperature-resistant electrodes; intermittent and also substantially continuous methods of advancing such feedstock, and of passing an electric arc therethrough, thereby forming—and subsequently collecting from overhead—desired gaseous product; also apparatus for performing the foregoing steps discontinuously and continuously, thus obtaining the non-self-combustible gaseous product—whose combustion effluent with added air or equivalent source of gaseous oxygen is substantially free of harmful gases, and also of liquid and/or solid particulates.

This is a continuation-in-part of Ser. No. 10/750,393 filed Dec. 31, 2003. and also a continuation-in-part of Ser. No. ______ filed 6 May 2004.

This invention concerns conversion of fragmentary carbon-rich feedstock, by electrical arcing, into non-self-combustible gas whose air-combustion effluent is free of noxious gases and particulates.

### BACKGROUND OF THE INVENTION

Underwater arcing of carbon to generate gaseous fuel, is shown in U.S. patents, as by Eldridge in U.S. Pat. No. 603,058; by Dammann in U.S. Pat. Nos. 6,183,608, 5,417,817 (et al.), and U.S. Pat. No. 5,159,900; by Lee (et al.) in U.S. Pat. No. 6,217,713; by Richardson in U.S. Pat. Nos. 6,299,738; 6,299,656 [et al.]; U.S. Pat. Nos. 6,263,838; 6,153,058; 6,113,748; 5,826,548, 5,792,435, 5,692,459, and 5,435,274. Others have contributed further to the art, but production of such environmentally desirable fuel is not yet a notable commercial success.

### SUMMARY OF THE INVENTION

This invention enables commercially successful production, of such an environmentally friendly non-self-combustible gaseous fuel, by exposing an aqueous slurry of fragmentary carbon-rich feedstock (e.g., anthracite ores, graphite ores, or pre-used carbon residues) to high-temperature electrical-arcing treatment, in an appropriate reaction zone of a high-temperature (e.g., plasma) reactor, and then retrieving the desired gaseous product—which emanates therefrom.

The reactor preferably contains multiple electrodes, supplied with adequately high-voltage electricity, programmable to conduct (fire) continuously or intermittently, separately or together, and at such intervals and for so long as may be economically productive.

Fragmented carbon-rich feedstock, is forwarded, preferably in aqueous slurry form, as by a suitable (e.g., helical screw) conveyor to a reaction zone defined in a high-temperature-resistant reactor, where the feedstock preferably is further compacted and/or flooded with water, as may be desired. Therein it is heated greatly, by and between arcing electrodes composed of tungsten or alloy(s) thereof noted for durability as in plasma-like conditions, for example. The desired gaseous product then evolves and is collected thereabove.

The desired gaseous fuel evolves and collects above whatever residue and water may remain, whence it is removed (as by venting and/or pumping), as for storage or for use on-site, or for shipment elsewhere, readily accomplished by freighter, pipeline, truck, etc.

### SUMMARY OF THE DRAWINGS

FIG. 1A is a block diagram of electrical equipment to implement this invention upon fragmented wetted carbon-rich feedstock; and

FIG. 1B is a block diagram of process steps thus accomplished.

FIG. 2A is a plan view of a (partly sectioned) first reactor of this invention, having means for conveying fragmented feedstock to a centrally located reaction zone, and—separately—similar means for conveying residue therefrom to a discharge location; and

FIG. 2B is a side view of its electrical grounding plate; and

FIG. 2C is a front elevation of the same grounding plate; and

FIG. 2D is a medial sectional plan of its electrode plate; and

FIG. 2E is a front elevation of that plate's electrode array.

FIG. 3A is a plan view (partly sectioned) of a continuous-flow reactor of this invention, having a grounding plate similar to that of FIG. 2A but curved (semicircularly), having a central rotatable hexagonal set of (six) electrode arrays, oriented with one array thereof directly opposite the midpart of the grounding plate; and

FIG. 3B is a front elevation of the reciprocally mounted nearly semicircularly curved electrically grounding plate, having a stowed (rest) position very near the semicircular (in plan) rear wall; and

FIG. 3C is a front elevation of the hexagonal electrode-array plate, mounted on two concentric vertical hollow supporting shafts, which provide passageways for electrical leads to the respective electrodes, and passageways for cooling water to all electrodes; and

FIG. 4A is a sectional elevation of the sidewall along a reaction zone of either embodiment, showing refrigerant circulation piping therein, and piping for circulation of water to—and release thereof above and laterally into—whatever feedstock may be therein (none illustrated in this view).

FIG. 4B is a longitudinal section through a single electrode, showing the (insulated) electrical lead connecting thereto, and its surrounding passageway for flow of cooling water thereto, also weep holes for discharging such water into surrounding slurry—not shown.

### DESCRIPTION OF THE INVENTION

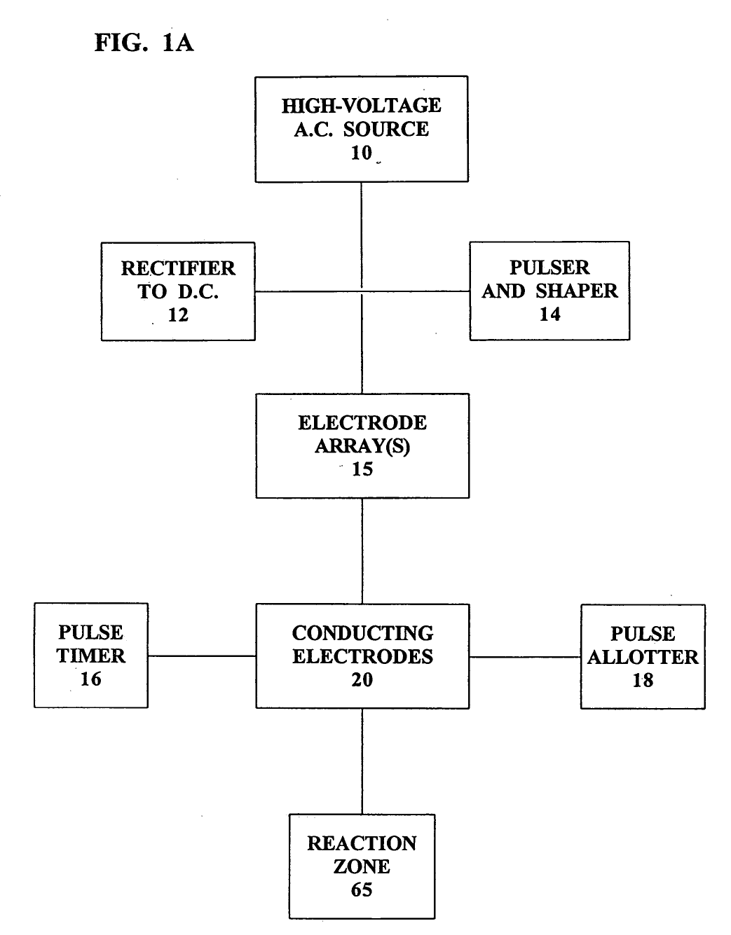

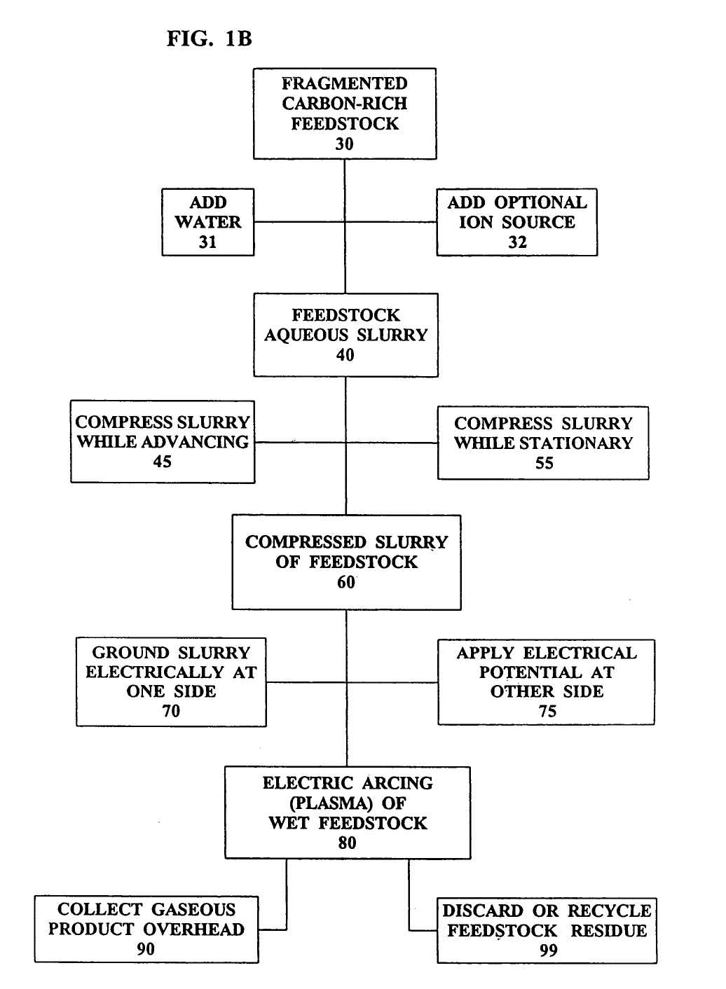

FIG. 1A identifies (reading downward from the top) electrical components and steps in the practicing of this invention. Suitable electricity is readily obtainable, as from an off-site High-Voltage A.C. Source 10 (e.g., a commercial supplier). Electricity therefrom or from a similarly suitable source is readily convertible, as by conventional Rectifier to D.C. 12. The electrical output therefrom (to be applied to the feedstock) is provided by Pulser and Shaper 14 to Electrode Array(s) 15 (examples of which are shown subsequently).

Pulse Timer 16 and Pulse Allotter 18 enable individual pulses of whatever predetermined size and shape to actuate (i.e., electrify or “fire”) Conducting Electrodes 20, whether at random or according to preselected patterns—whichever may be preferred—in a designated Reaction Zone 65. It will be understood that the actuators of these various steps—and/or their effects upon the feedstock being treated—may be under human and/or electronic surveillance, and also that adjustments or variations may be made therein as desired.

FIG. 1B traces (also reading downward) the path of Fragmented Carbon-Rich Feedstock 30 as a related sequence of events: Add Water 31, and—perhaps—Add Optional Ion Source 32 (e.g., acetic acid), resulting in Feedstock Aqueous Slurry 40; then Compress Slurry While Advancing 45 (to the reaction zone), and/or Compress Slurry While Stationary 55 (as in that reaction zone, for example).

FIG. 1B shows steps, performed on resulting Compressed Slurry of Feedstock 60, including Ground Slurry Electrically at One Side 70, and Apply Electrical Potential (e.g., A.C.) at Other Side 75, culminating in Electric Arcing of Wet Feedstock 80. Final steps are Collect Gaseous Product Overhead 90, and Discard or Recycle Feedstock Residue 99.

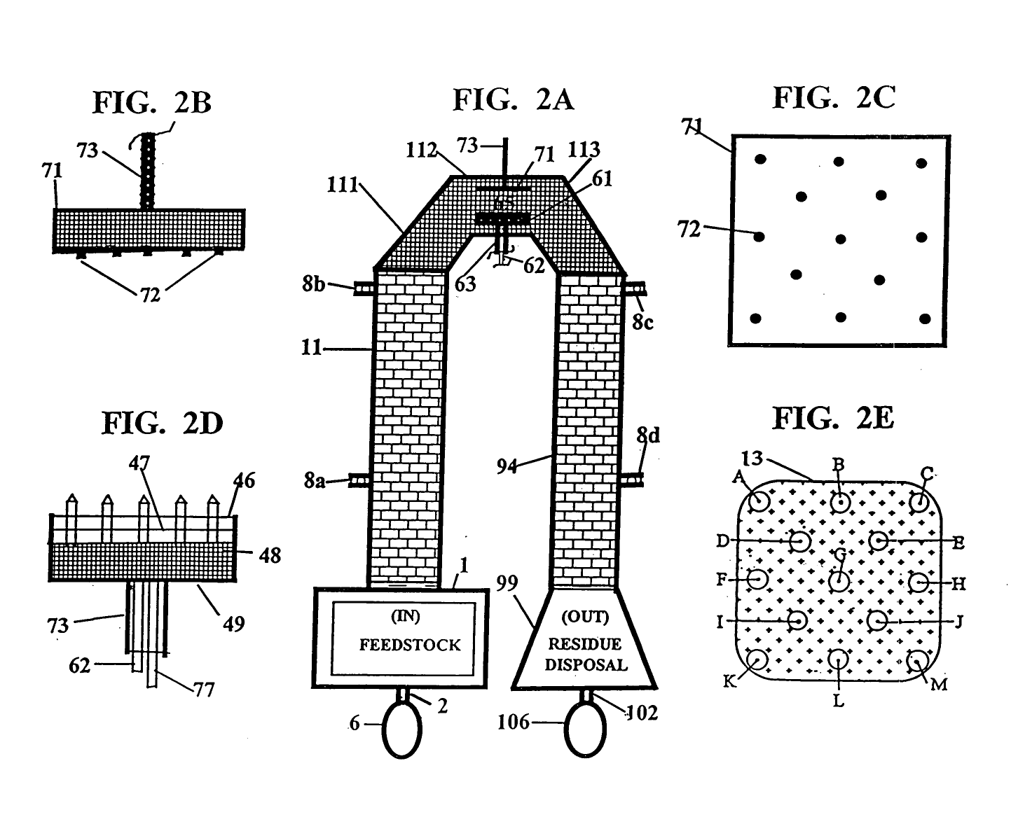

FIG. 2A shows, in plan (partly in section), a first reactor structure according to this invention, with inverted U-shaped outline (angle-cornered) from Feedstock (IN) hopper 1 to Residue Disposal (OUT) platform 99. Included are parallel input housing 11 and output housing 94—shaded for brickwork structure. Three intervening path legs (lightly shaded to sugest contents while revealing installed components) comprise angled initial portion 111, then mid-leg portion 112 (the site of reaction zone 65), and finally last angled portion 113 connecting to output housing 94.

Both parallel input and output housings contain a conventional conveyor (e.g., helical-screw type) not illustrated here. At the feedstock input entrance (lower left) is conventional engine or motor 6 with drive shaft 2 for the first (hidden) conveyor of conventional design, within first conveyor housing 11. Shown at residue exit (lower right) is similar drive engine or motor 106 with drive shaft 102 for a similar second or output conveyor (not shown) in parallel output housing 94.

Adjustable water inlets and/or drains 8a and 8b for the input feedstock, and 8c and 8d for feedstock residue or waste, adjoin the respective housings to facilitate desire aqueous slurry viscosity.

Visible despite light shading of the contents within centrally located reaction zone 65 are the components between which the desired electric arcing occurs. Grounding plate 71, shown in its rest or stowed position adjacent the short transverse mid-portion of the path, is mounted upon externally grounded outer shaft 73, which is reciprocatable by conventional exterior drive means (not shown).

Accessory electrode array plate 61, shown in its opposing wall-adjacent rest or stowed position, is mounted on its own similarly reciprocable outer tubular shaft 63, which is hollow to accommodate (cabled) electrical leads from the exterior to the respective electrodes, and also, via tubular inner shaft 62, to provide cooling water flow to all the electrode housings. At least one (usually both) of these shaft mountings is (are) reciprocatable—by conventional means (not shown here) from such rest or stowed position near the reactor wall inwardly into compressive contact with intervening feedstock slurry, so as to facilitate desired electric arcing. Slurry passage through such reaction zone may preferably be slowed, or even interrupted, during such compression and electric arcing.

FIG. 2B shows (also in plan, in more detail) electrical grounding plate 71 on reciprocatable shaft 73, also its (five) rows and columns (five) conductive nubs 72 each extending a relatively modest distance from the face of the plate.

FIG. 2C shows the identical grounding plate in front elevation. Its (five) rows 71 and columns of nubs 72 thereon, extending a short distance from the face of the plate, appear as black spots. They are juxtaposable to a similar pattern of respective electrodes on electrode plate 15—itself shown head-on in subsequent FIG. 2E.

All the grounding nubs 72 and their metal plate 71 are at the same voltage (preferably grounded). The nubs are located so as to be juxtaposable to respective electrode ends when the space between the respective plates is reduced to facilitate electrical arcing.

FIG. 2D shows, in side elevation (partly sectioned) electrode array housing plate 49, with its electrodes supported on the end of hollow grounding shaft 73, surrounding both cable 62 of electrical leads and cooling-water tubing 77—to the electrodes. Base 48 (shaded) of the housing preferably is aided, in maintaining proper orientation of the extending arrayed electrodes, by a pair of wireworks 46 and47, wrapped about all of the respective electrodes in turn, at selected intervals above their base plate. Each wire is tightly wrapped in a criss-cross pattern therearound to stabilize each electrode perpendicular to the supporting array plate.

Aquatic and electrical connecting means extend, via respective sheathings, through the hollow supporting shaft to all electrodes in the array. Electrical connections are made to respective electrode hot-wires, whereas water flows into all electrode housings alike.

FIG. 2E shows electrode array plate 13 head-on, provided with an array of thirteen electrodes (A to M) in five rows and columns (cf. a 5-spot domino with added outer 3-spot rows along each side).

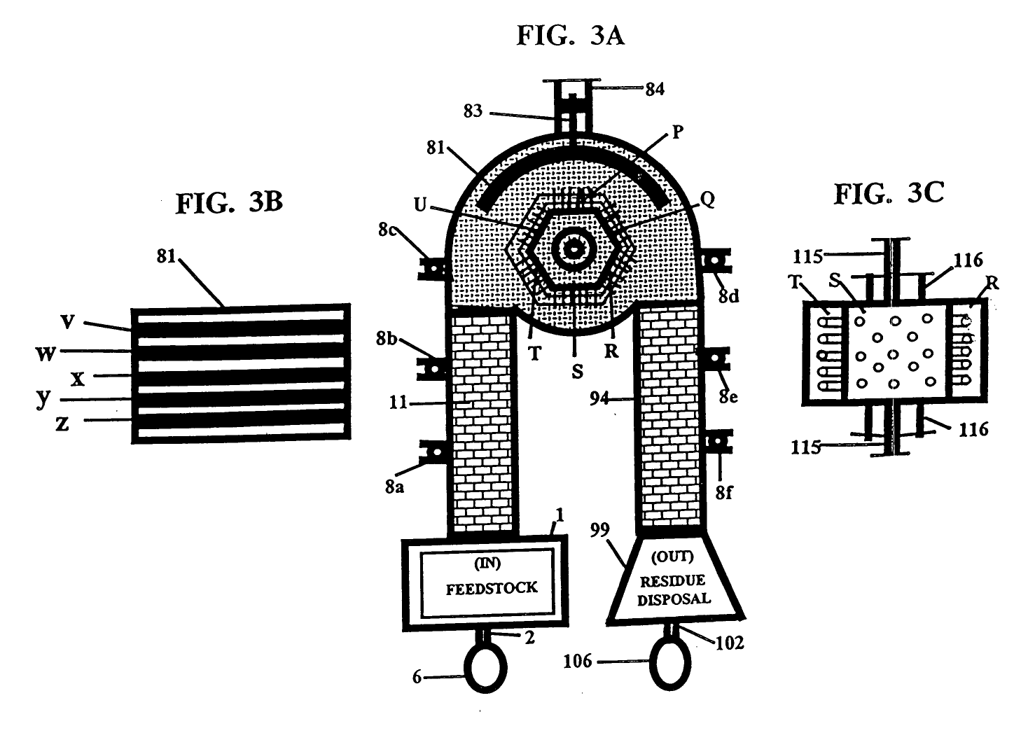

FIG. 3A shows a second reactor embodiment of the present invention with a smoothly curvilinear—not angular—transverse path (more lightly shaded to reveal even more complex installed components), to and from reaction zone 65 located halfway along the connecting pathway between input and output conveyors. Such smooth path can be more conducive to continuous processing than is a more angular path.

The overall feedstock path extends similarly from hopper 1 via such an input conveyor (hidden) within housing 11 to and through reaction zone 65—now centered along a smoothly curved path—then continues out of the reaction zone via a like conveyor (hidden) within outhousing 94 to the exterior—and discharge onto apron 99.

Shown in FIG. 3A, at its stowed or rest position against the curved outer wall, is similarly curved grounding plate 81 supported on shaft 83 within cylinder 84. Such mounting enables the plate to move horizontally inward toward the axis of curvature, to compact slurried feedstock, and to facilitate electrical arcing therein, and then to return to rest—via conventional external means (not shown).

FIG. 3B shows curved grounding plate 81 face-on, having a half dozen slightly raised horizontal rows (V, W, X, Y, and Z (shown as black streaks) replacing the more numerous individual nubs on the flat plate of the previous embodiment.

This curvilinear embodiment of the present invention also has (as shown in dim outline in FIG. 3A) a hexagonal cylindrical array of (six) electrode plates—instead of a single such plate—each with an electrode array like that of the previous embodiment. Concentric small and large vertical axles 115 and 116 support a half dozen plates: (P, Q,R, S, T and U), all shown therein edge-on from above, equidistant from the rotation axis.

As rotation of this multiplicity of array plates inherently twists the electrical leads to the respective electrodes, shortening the effective length of the leads, operations may be interrupted from time to time for rewinding sessions, as at periodic lulls in normal operations. Alternatively, rather complex exterior twist-cancelling mechanism (not described or shown here) may be provided.

FIG. 3C shows head-on (as in FIG. 3B but opposite thereto and scaled down a bit), such an electrode plate S face-on, plus its flanking slantwise plates R and T. Wide vertical axle 116 is visible extending both above and below the array group, which it supports around smaller vertical axial tube 115, which carries cooling water to and from the electrodes. All thirteen electrodes on the facing plate are visible end-on (as small circles). Five electrodes on each of the two adjacent slantwise plates (one on on either side) are visible. (No attempt is made here to depict the pair of very fine stabilizing wireworks wound about each electrode in turn.)

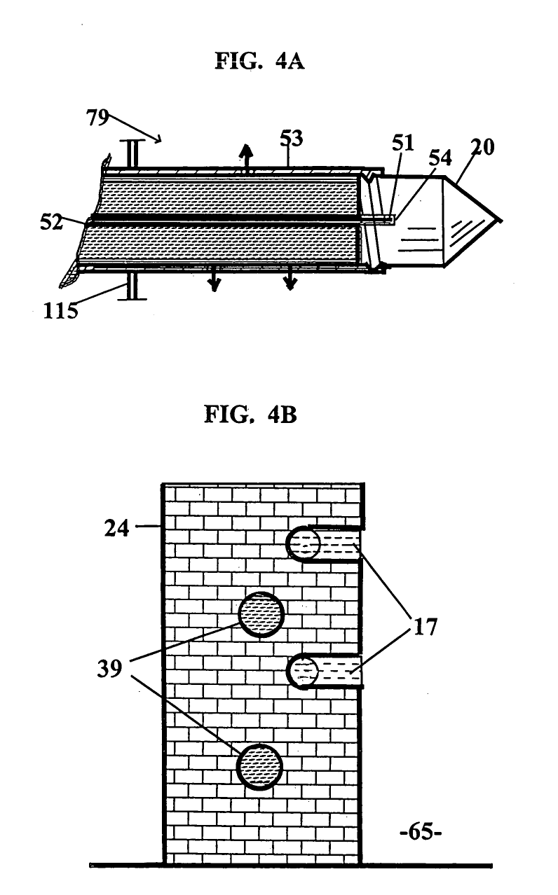

FIG. 4A shows electrode 79 suited to either the single-array or the multiple-array embodiment of this invention, as seated in and extending from an array plate (115), and sectioned lengthwise except at its conical tip 20, whether screwed (as shown), snapped, or otherwise secured in its housing end. Axial hotwire 51 has surrounding insulation 52 except at its end shown seated within axial depression 54 in the adjoining bottom or seat of the cylindrical electrode. The exposed end tapers conically—but might be multihedral instead. Outer wall 53 of the housing tubing has lateral outlets or “weep holes” (note outward arrows) enabling outflow of cooling water from whatever external source into the adjacent slurry (neither shown).

FIG. 4B shows, in transverse section, part of a reaction zone wall 24 shaded as composed of brick, with a pair of refrigerant circulation channels 39 therein, useful in maintaining its structural integrity, also a pair of water channels 17 opening into adjacent reaction zone 65, such as above and below any feedstock slurry surface (not shown) to aid in generating and collecting gaseous fuel.

Other suitable wall-construction materials include concrete, stone, ceramic materials, even high-temperature-resistant metals, e.g., tungsten or one more of its alloys noted for such capability, such as also is frequently chosen for electrode composition(s).

Useful variations may be made in the subject invention, as by adding, combining, deleting, or subdividing apparatus, compositions, component parts, or steps—while retaining many of the benefits of this invention, which itself is defined in the following claims.

1. Method of converting an aqueous slurry of fragmented carbon-rich feedstock, within a high-temperature reaction zone, into a non-self-combustible gaseous product, combustible upon contacting air or equivalent source of oxygen, comprising the following steps:
(a) conveying such a feedstock slurry to such a reaction zone located between at least two electrodes therewithin, the electrodes being subject to respectively diverse electrical potentials; and
(c) applying a voltage differential across such electrodes and thereby generating electric arcing within the slurried feedstock therebetween, thus fostering formation of desired gaseous product.

2. Method according to claim 1, including a further step of progressively reducing the distance between the diverse electrodes, at least while the feedstock slurry is between the electrodes.

3. Method according to claim 2, including thereby compressing the aqueous feedstock slurry by and between the electrodes.

4. Method according to claim 2, including thereby fostering the initiation of electric arcing between the electrodes.

5. Method according to claim 1, including a further step of discontinuing the holding of aqueous feedstock slurry substantially stationary within the reaction zone, during such electrical arcing.

6. Method according to claim 1, including fostering passage of aqueous feedstock slurry through the reaction zone, especially during arcing, by correspondingly movable mounting of electrodes.

7. Method according to claim 6, wherein the movable mounting of electrodes is accomplished by arranging plural sets of electrodes about a mutual rotation axis thereof, and equating the rotation rate of the electrodes thereabout to the rate of slurry travel thereby.

8. Apparatus for converting an aqueous slurry of fragmented carbon-rich feedstock into a non-self-combustible gaseous product, combustible—upon contact with air or other source of oxygen—into (a) heat, and (b) combustion effluent free of noxious constituents;
comprising the following:
means forming such feedstock into an aqueous slurry thereof;
means for conveying such aqueous slurry into a reaction zone;
means in such zone for compressing the aqueous slurry; and
means in such zone for subjecting such aqueous slurry to electric arcing between electrodes of diverse electric potential.

9. Apparatus according to claim 8, wherein such reaction zone contains mechanical means for compressing such aqueous slurry, and contains electrical leads from external means effective for applying to such aqueous slurry electrical impulses of sufficiently diverse electrical polarities for electrical arcing in such aqueous slurry and consequent evolution of desired gaseous product therefrom.

10. Apparatus according to claim 8, wherein such reaction zone contains electrically conductive means of diverse polarities located opposite one another, and having connected thereto mechanical means enabling supervised movement of at least one such means toward the other, thereby compressing any slurry therebetween and enabling electrical arcing therein, and also enabling supervised movement away from the other, thereby precluding electrical arcing therein.

11. Apparatus according to claim 10, including at least two electrode plates, at each of two such widely diverse electrical polarities that—at some minimum spatial separation thereof—an electric arc results within aqueous carbon-rich feedstock located therebetween, whenever sufficient electrical charge disparity exists between the conductive members of the respective plates.

12. Apparatus according to claim 11, wherein at least one such plate contains a plurality of electrodes subject to such arcing.

13. Apparatus according to claim 12, wherein such electrodes are subject to controlled electrical pulsing thereof, separately or together, under external control, and preplanned or contemporaneous.

14. Apparatus according to claim 13, wherein such electrodes are subject to continuous and/or discontinuous electrical conduction as previously scheduled, or are subject to currently random pulsing.

15. Apparatus according to claim 14, wherein multiple plates of electrodes comprise a multi-sided array of like plates surrounding a rotational axis and facing outwardly therefrom.

16. Apparatus according to claim 15, wherein such multi-sided array of electrodes rotates about such axis, in accordance with the substantially unidirectional movement of adjacent feedstock slurry.

17. Apparatus according to claim 16, wherein the multi-sided array of electrodes has, for example, at least a half dozen array plates arranged in a corresponding multihedral pattern, as viewed along such axis.

18. Gaseous fuel produced according to the method of claim 1.

19. Gaseous fuel made produced using the apparatus of claim 8.
